(19) United States
(12) Patent Application Publication
(10) Pub. No.: US 2025/0236505 A1
(43) Pub. Date: Jul. 24, 2025

(54) AUTOMATED BEVERAGE POURING AND MIXING DEVICE AND SYSTEM

(71) Applicant: ROTENDER, INC., West Hollywood, CA (US)

(72) Inventors: Parker Alban, West Hollywood, CA (US); Daniel Busby, West Hollywood, CA (US); Gregory Evans, West Hollywood, CA (US); Christopher Garcia, West Hollywood, CA (US); Alec Kanyuck, West Hollywood, CA (US); Benjamin Winston, West Hollywood, CA (US); Evan Yu, West Hollywood, CA (US)

(73) Assignee: ROTENDER, INC., West Hollywood, CA (US)

(21) Appl. No.: 18/839,392

(22) PCT Filed: Feb. 16, 2023
(86) PCT No.: PCT/US23/13259

§ 371 Date: Aug. 16, 2024

Related U.S. Application Data
(60) Provisional application No. 63/268,126, filed on Feb. 16, 2022.

(51) Int. Cl. B67D 3/00

(52) U.S. Cl. CPC B67D 3/0003; B67D 3/0016; B67D 3/0087

(57) ABSTRACT

One example device includes a computer configured to receive a beverage order, a carousel with bottles and configured to rotate one or more of the bottles into a dispense position and provide one or more liquid dispense operations to a container disposed in a beverage dispenser area based on one or more bottle selection commands included in the beverage order, and actuation elements affixed to a corresponding motors which actuate one or more release valves of a liquid dispenser nozzle linked to different liquid sources to provide one or more additional dispense operations to the beverage dispenser area based on one or more liquid source selection commands included in the beverage order.

### TECHNICAL FIELD

This application generally relates to automated beverage creation and more specifically to an automated beverage pouring and mixing device and system.

### BACKGROUND

The beverage industry continues to apply technology to modernize and simplify the beverage selection and creation processes. Restaurants and related food and drink industries have adopted standalone machines which can produce a large variety of mixed fluid beverages including water, soda, syrups, coffee, juice, milk and other types of fluid into a single beverage selection.

### SUMMARY

One example embodiment may provide a device that includes one or more of a computer configured to receive a beverage order, a carousel with a plurality of bottles and configured to rotate one or more of the plurality of bottles into a dispense position and provide one or more liquid dispense operations to a container disposed in a beverage dispenser area based on one or more bottle selection commands included in the beverage order, and a plurality of actuation elements affixed to a corresponding plurality of motors which actuate one or more release valves of a liquid dispenser nozzle linked to a plurality of different liquid sources to provide one or more additional dispense operations to the beverage dispenser area based on one or more liquid source selection commands included in the beverage order.

Another example embodiment may include a method that includes one or more of receiving a beverage order from a computer, rotating a carousel, with a plurality of bottles, to present one or more of the plurality of bottles into a dispense position, providing one or more liquid dispense operations to a container disposed in a beverage dispenser area based on one or more bottle selection commands included in the beverage order, and actuating one or more release valves of a liquid dispenser nozzle linked to a plurality of different liquid sources, via one or more of a plurality of actuation elements affixed to a corresponding plurality of motors, to provide one or more additional dispense operations to the beverage dispenser area based on one or more liquid source selection commands included in the beverage order.

Another example embodiment may include a non-transitory computer readable storage medium configured to perform one or more of receiving a beverage order from a computer, rotating a carousel, with a plurality of bottles, to present one or more of the plurality of bottles into a dispense position, providing one or more liquid dispense operations to a container disposed in a beverage dispenser area based on one or more bottle selection commands included in the beverage order, and actuating one or more release valves of a liquid dispenser nozzle linked to a plurality of different liquid sources, via one or more of a plurality of actuation elements affixed to a corresponding plurality of motors, to provide one or more additional dispense operations to the beverage dispenser area based on one or more liquid source selection commands included in the beverage order.

### BRIEF DESCRIPTION OF THE DRAWINGS

FIG. 1 illustrates an automated beverage pouring and creation configuration according to example embodiments.

FIG. 2 illustrates a liquid measurement sensing configuration according to example embodiments.

FIG. 3 illustrates bottle securing configuration according to example embodiments.

FIG. 4 illustrates a bottle securing carousel configuration according to example embodiments.

FIG. 5 illustrates a multi-input liquid mixing configuration according to example embodiments.

FIG. 6A illustrates an example of a liquid dispenser controller configuration without the liquid dispenser gun according to example embodiments.

FIG. 6B illustrates an example of a liquid dispenser controller configuration with the liquid dispenser gun according to example embodiments.

FIG. 7 illustrates an example of a pusher bracket configuration according to example embodiments.

FIG. 8 illustrates another example liquid measurement sensing configuration according to example embodiments.

FIG. 9 illustrates an example side view of a liquid volume sensing component, and various liquid dispensers aligned to provide a mixed liquid to a container according to example embodiments.

FIG. 10 illustrates an ice dispensing configuration integrated with the liquid measurement and distributing configuration according to example embodiments.

FIG. 11 illustrates an ice sensing ring utilizing sensors to measure ice distribution to a point of dispensing according to example embodiments.

FIG. 12A illustrates a container sensing and securing configuration according to example embodiments.

FIG. 12B illustrates a container sensing and securing configuration according to example embodiments.

FIG. 13 illustrates a sideways view of a container sensing and securing configuration where a lever in an engaged position according to example embodiments.

FIG. 14 illustrates a network system diagram of the devices and network elements used to control and operate the beverage dispensing device according to example embodiments.

FIG. 15 illustrates an example flow diagram of an example method of operation according to example embodiments.

FIG. 16 illustrates a computer readable and instruction storing system that can be used to perform any of the computer based operations and procedures according to example embodiments.

### DETAILED DESCRIPTION

It will be readily understood that the instant components, as generally described and illustrated in the figures herein, may be arranged and designed in a wide variety of different configurations. Thus, the following detailed description of the embodiments of at least one of a method, apparatus, device, non-transitory computer readable medium and system, as represented in the attached figures, is not intended to limit the scope of the application as claimed, but is merely representative of selected embodiments.

The instant features, structures, or characteristics as described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

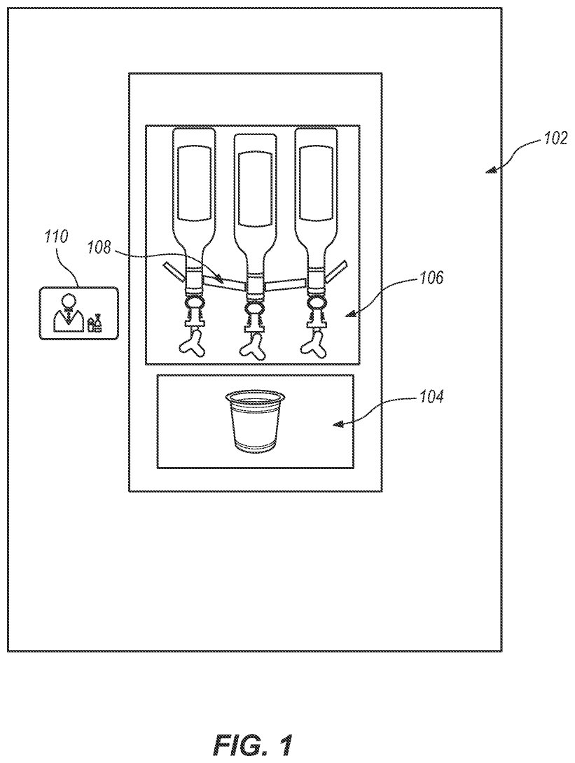

FIG. 1 illustrates an automated beverage pouring and creation configuration according to example embodiments. Referring to FIG. 1, a device 102 may be a standalone machine that represents the activities and results generally associated with a bar and/or bartender. For example, the device 102 may be any shape (rectangular, square, and/or other shaped object) with certain components, such as a window or other partition 106 on a front portion and/or side portion of the device to observe various bottles of alcohol (and/or other substances). These bottles are affixed to a rotating carousel 108 where the bottles can rest upside down to permit alcohol to flow from the bottles to a drink receiving area 104.

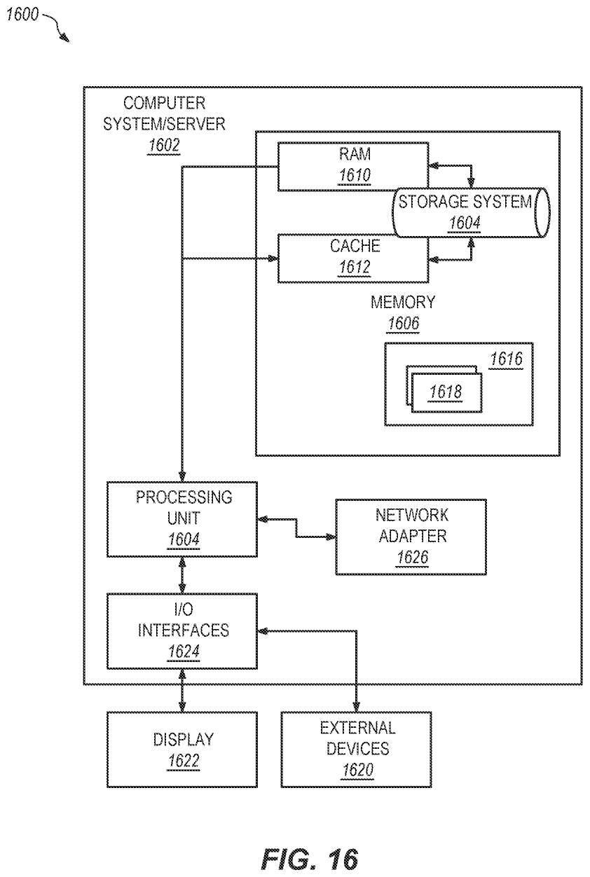

A computer interface or display 110 may be communicably coupled to a computer (see, for example, FIG. 16) that includes a memory, instructions, communication interfaces, etc. The computer may control servo motors to move servos which actuate buttons on a liquid dispensing gun or other apparatus. The interface/computer may also control ice distribution, bottle rotation via the carousel 108 and liquid release from the bottles into the reservoirs for accurate measurement prior to distribution to a cup in the drink receiving area 104.

The device 102 may have a customizable machine exterior, which may permit different names and/or logos to be represented on the body of the device. The outer shell of the device can be customized with additional displays, artwork and designs to reflect sponsorships, brand logos, iconography or other specified designs. The device may include a port (not shown) to be integrated with an in-house water line, a portable water source or an in-machine water tank with a distribution manifold to multiple locations. A ‘poka-yoke’ solution may also be present to ensure a correct bottle is loaded into a correct slot of the carousel.

During a startup process, a homing sequence is invoked for the carousel to position itself appropriately. The carousel 108 may have a protruding lip or other protruding element (not shown) at a fixed point on the carousel, which rotates along with the rest of the carousel. There may be a motion detector mounted which is stationary on the device. When the protruding lip passes through the motion detector, feedback is sent to a processor for appropriate homing and positioning prior to an order being fulfilled. For example, the protruding lip may be a bump, knob or other protrusion that triggers a sensor to demonstrate a home position for the system to know which bottle is at which position. In another example, a linear actuator provides a homing process. On startup, a homing sequence is invoked for the linear actuator (also referred to as a vertically actuated ring for a pressure-activated valve) to position itself appropriately. The actuator moves downward until it hits a switch (such as a mechanical switch) mounted at a fixed point. Feedback is sent to the processor from the switch and actuation stops. The vertical position is used for appropriate positioning.

Beverage orders may be placed from a user device, such as a smartphone or computer (e.g., smartwatch, tablet, laptop, vehicle computer, wearable computer, etc.) and sent over the Internet to a receiver of the computer included in the beverage distribution device 102. For example, a user may launch an application, select a drink, such as a gin and tonic, bourbon and cola, etc., as well as a preferred amount of ice, type of liquor, etc. The selection may be paid for by an application vendor service and the drink order may be sent to the device 102. When the user scans a QR code, enters a code, etc., or is physically near the device 102 as measured by a wireless communication signal, then the drink may begin to be poured into a cup which his provided to the dispenser area. The menu may be based on a unique URL that can be visited via the customer's mobile device and may be ordered from via a web application associated with the device 102. When a drink order is submitted and payment is made, the on-board computer and/or display 110 is updated with a unique code for the user to enter (or QR code to scan) to ensure their physical presence at the device. When the code is entered (or scanned), the machine will begin pouring the drink. Venue owners may opt in for “touchless ordering only” on their devices to prevent users from placing orders via the on-board display or may permit such order entry. Another approach to the customer receiving access to the device can include biometric authorization, such as fingerprint, facial recognition or other biometric approaches. In another embodiment, the user can approach the machine and a virtual bartender interface, that can appear in the display 110, could then communicate with the customer and offer a drink order confirmation based on the user being recognized and/or based on a previous order. The purchase is then secured by the user authorizing the drink via a confirmation (such as a favorite word or a yes or no response) and payment being made.

The automated configuration provides a real-time inventory tracking function that can inform a device of a need for reorders based on expected output. The application may provide payment processing for drinks via the application. The automated system may provide tracking of how many drinks a user has ordered and the ability to limit an individual user from unsafe levels of consumption. The application may also scan multiple ID cards to ensure age compliance with orders for multiple users. Another option may include visual avatars and bartender personalities to be included as part of the software interface. Virtual bartender/characters may be displayed on the mobile web application and via the on-board computer interface 110 and can greet customers and provide entertainment during a drink service. The characters are selected on the application by the customer or can be randomly assigned.

The device 102 may be transparent in certain places to permit those present to see into the device and the operation of the liquor dispensing components. Machine learning and artificial intelligence provide optimization for drink recommendations based on user profile information, preferences, location and/or time of day. The device 102 may have one or more sensors in connection with the computer associated with the user interface 110. The sensors can identify a user by facial recognition and/or voice recognition, for example, and offer to provide the same drink order previously by the user account at a different time. A virtual bartender can appear and offer the same drink once the recognition is complete. The virtual bartender may appear on the user interface and communicate with the user describing information related to the order as well as general information related to current events, sports, weather and the like. Once the user confirms another drink, the device 102 may dispense another drink. In one example, liquid from a bottle (e.g., liquor, mixers, etc.) via a gravity-fed dispensing mechanism, beer kegs, carbonated mixers, water, wine bottles and pouches, may all be integrated into the feeder lines which coordinate with the bottles and/or liquid dispensing gun. Additionally, a small syringe or alternative liquid dispenser (not shown) may be used as another option that drops small amounts of liquids for infused flavors, bitters and other concentrated juices for an upcharge or for more advanced cocktail mixes.

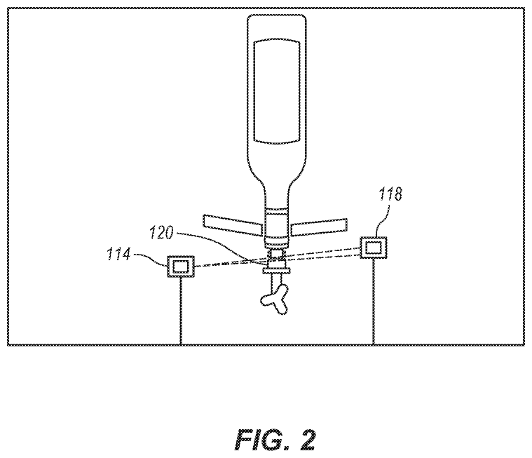

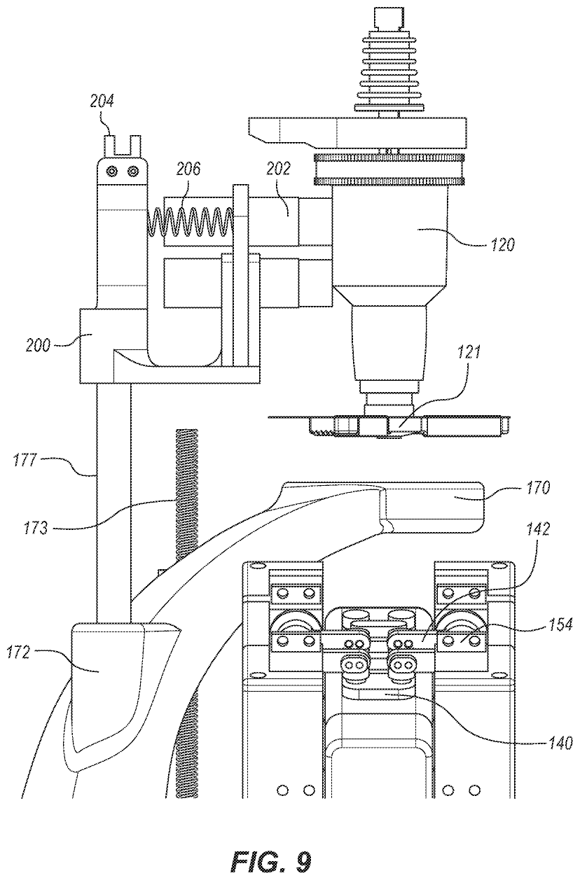

FIG. 2 illustrates a liquid measurement sensing configuration according to example embodiments. Referring to FIG. 2, the liquid measuring sensor configuration is illustrated by using a transparent liquid filling reservoir 120 (also referred to as a shot dispenser (SD)). The contents of the bottle above the dispenser configuration may be provided by gravity into the reservoir once a release valve is actuated. In this example, a line laser and/or infrared (IR) beam sensor (e.g., transmitter and receiver pair(s)) can sense the amount of liquid in the bottle and/or in the dispenser reservoir 120. Abeam is sent via a transmitter 116 which is detected via a receiver 114. The beam may be calibrated to a certain level so when the liquid reaches that level the sensor indicates a stop action to prevent further filling. The sensor provides feedback to the processor to control the vertical actuator accordingly to stop permitting liquid to pass into the reservoir 120. The SD is pressure-activated and a rigid element that comes into contact with the SD can activate the fluid to drop down with gravity into the dispenser area. The SD has a valve that is pressure sensitive and is spring reinforced to cause the valve to retract back into a closed position when the force is removed (see, for example, FIG. 9). A first command may elevate the pusher element to press on the release valve so liquid falls into the reservoir 120. Another command may stop pressing against the valve so the liquid stops which is triggered by the liquid detection and feedback provided by the liquid sensor 116.

The configuration may automatically install full bottles into the slots of the carousel, and when they are empty, automatically dispose them by dropping them out of position and replacing them with new bottles or transmitting alerts to replace the empty bottles. Other approaches to monitoring the exact amount of alcohol or other liquid dispensed may be performed with a scale for weight measurement, capacitance via active electronic components, etc. Automatic ice making and dispensing is also performed to control an amount in customer's glass per a set amount or preference.

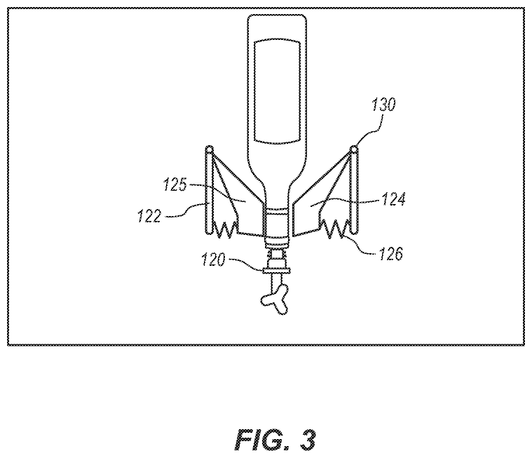

FIG. 3 illustrates a bottle securing configuration according to example embodiments. Referring to FIG. 3, the bottle is illustrated as being upside down and held in place with a pair of braces 124/125 which form a spring-loaded clamshell with a pair of springs 126. The clamshell may be hinged in one corner with a pair of hinges 130 attached to a frame 122. The mouth of the bottle may be affixed to the dispenser configuration with a reservoir 120 to populate an amount of liquid prior to measuring and dispensing.

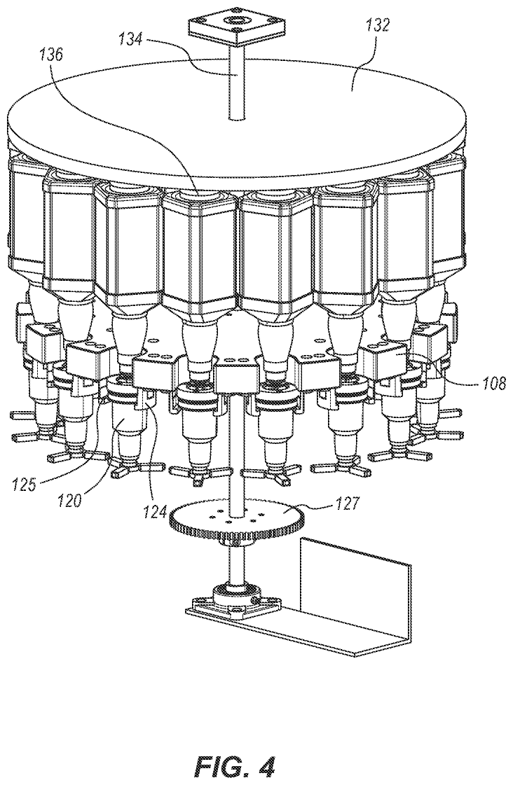

FIG. 4 illustrates a bottle securing carousel configuration according to example embodiments. Referring to FIG. 4, the carousel wheel 132 may include a top wheel which is pressed against the bottles by a set of pads 136 which are spring loaded and/or backed by a clamp to hold the bottles in position. The clamp may have a release lever which can be lifted and pressed down to place a stop force on the bottom of the upside-down bottle thereby clamping the bottle into position, so the bottle is held firmly in place until it is removed.

The carousel moves in a circular motion about an axis rod 134 which is connected to a motor wheel or sprocket 127 with teeth which are actuated by a turning motor set in a contiguous position with the sprocket 127. A belt system may also be used to turn the wheel carousel 108 or other power transfer mechanisms. The wheel has a plurality of grooves where the bottle neck can be set into place and held in position by the brace arms 124/125 on either side of the bottle neck. The reservoir 120 fills with liquid from the bottle when an actuation occurs to permit the liquid to drop from the bottle into the reservoir beneath the bottle. The actuation occurs based on a signal from the computer of the device 102 (see, for example, FIG. 16) and based on a measurement system that detects an amount of liquid, such as 1 ounce, 1.5 ounces, 2 ounces, etc. A dispenser 121 (see, for example, FIG. 9) is also controlled by a push actuation and/or via an optional automated motor system. Once the liquid is measured and is determined to be accurate, the liquid may dispense via a pressing action by the presser element that presses against the dispenser 121 (which may be spring loaded). The wheel 132 turns to place the selected bottle in front of the dispenser so the correct liquid is dispensed and measured.

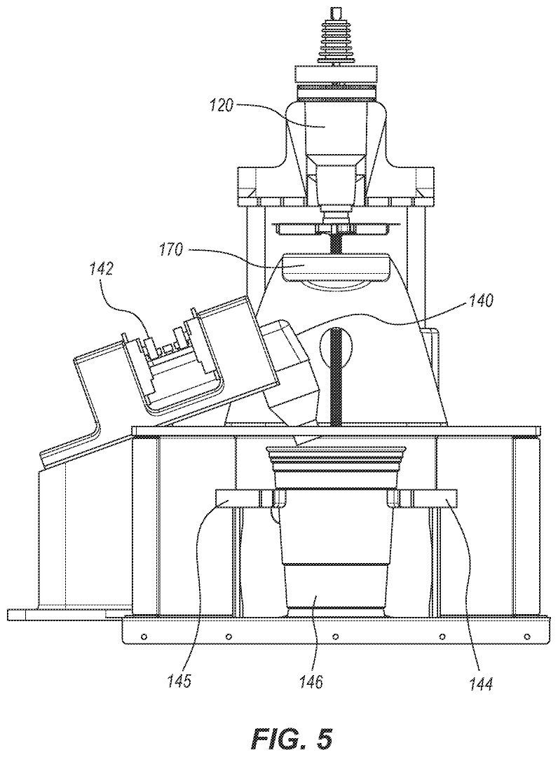

FIG. 5 illustrates a multi-input liquid mixing configuration according to example embodiments. Referring to FIG. 5, the reservoir 120 is illustrated above a release valve that is pressed against a ring top portion of a presser element 170 when liquid from a bottle is intended to drop into a container 146 beneath the dispenser. The presser element 170 is moved vertically up a screw column to contact the release valve 121 (see, for example, FIG. 9). The container 146 is held in position by two guiding arms 144/145 with an elastic geometry which may be connected to a sensor to identify whether the container is present. The liquid gun dispenser 140 is locked into position and actuated for its various release buttons (e.g., liquid 1, liquid 2, liquid 3, etc.) by a servo knob or ‘horn’ that rotates by a servo motor, linear actuator or other actuating mechanisms controlled by a controller of the computer. The type of liquid from the gun can be identified from the order and the correct servo horn 142 can rotate to press the gun buttons to release additional liquid to make the selected drink.

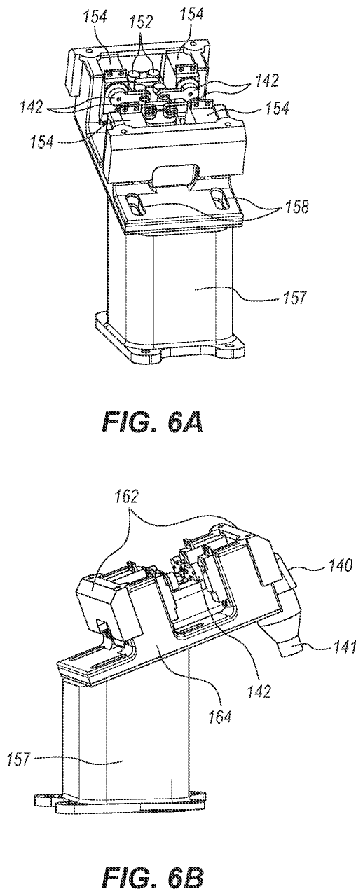

FIG. 6A illustrates an example of a liquid dispenser controller configuration without the liquid dispenser gun according to example embodiments. Referring to FIG. 6A, the buttons 152 on the gun are actuated by the servo horns 142 which are related to the liquid options integrated with the gun. The servo horns 142 are actuated by the servo motors 154 which cause a movement (i.e., rotation) to occur to actuate the buttons 152. Guide channels 158 are used to mount the configuration to a base 157 and to adjust the position of the configuration so the dispenser area is setup for multiple liquid dispending options. Other options for actuating the gun buttons may be by linear actuator or other actuating mechanisms.

FIG. 6B illustrates an example of a liquid dispenser controller configuration with the liquid dispenser gun according to example embodiments. Referring to FIG. 6B, the spring-loaded clamps 162 hold the gun in position and the gun head 140 and corresponding nozzle 141 are positioned to dispense liquid into the container via the servo horn 142 rotating and pressing the gun button(s) to make the selected drink. A bracket 164 also holds the gun in place above the base 157.

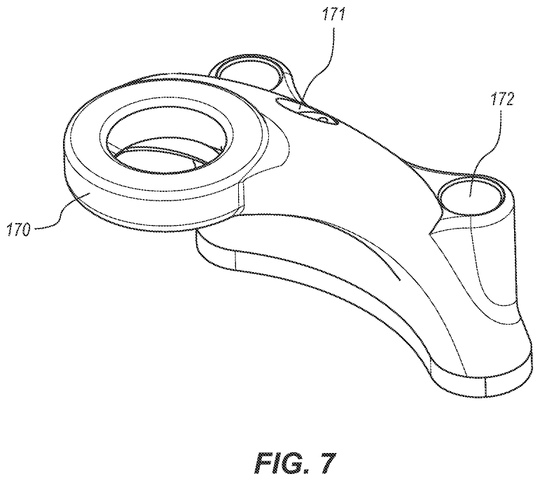

FIG. 7 illustrates an example of a ‘pusher’ bracket configuration according to example embodiments. Referring to FIG. 7, the rigid ‘pusher’ with ring configuration 170 supplies force to permit the liquid to exit the valve of the bottle dispenser. The pusher 170 includes one or more linear sleeve bearings 172 to be bolted into position for a secure arrangement on a base. The channel 171 permits a lead screw to move the pusher element 170 upward with a force to permit the dispenser on a particular bottle to drop the liquid into the container below.

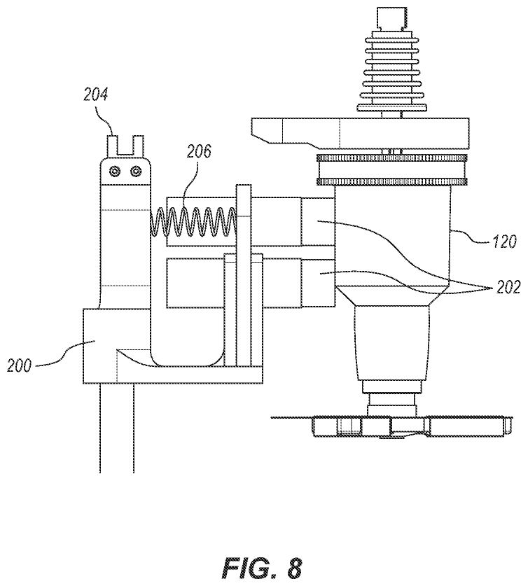

FIG. 8 illustrates another example liquid measurement sensing configuration according to example embodiments. Referring to FIG. 8, the alternative liquid sensing arrangement may use electrical signals via capacitive measurements, inductive measurements, resistive measurements, etc., to determine an amount of liquid present in the reservoir 120. The liquid is dispensed into the reservoir 120 to permit the electrical signals to be used as a measurement for an amount of liquid based on the sensors 202 supported by the sensor bracket 200 in contact with or proximate the reservoir 120.

To detect a state of the single/double shot dispenser (SD) or reservoir 120 there are two capacitive/resistive/inductive/ultrasonic (or any variation in type and number thereof) sensors mounted to a spring that will press the sensors up against each SD as it moves into the dispensing position. The liquid sensors are able to detect the presence of liquid in the area directly in front of them. The liquid sensors sensitivity is adjustable to permit for calibration of when it is determined that an SD is full or empty. The liquid sensor mount press fits onto the top of the linear shaft rails to mount rigidly to a base. The carousel homing optical gate switch (photo-interrupter 204) is also mounted to the top of the sensor mount, and interacts with a brush system (for example, nylon whiskers or other low-resistance material) mounted to the spinning carousel to detect the home location of the carousel. The protrusion from the main liquid sensor mount body is a spring that permits the two liquid sensors to move significantly when the SD rotates into position. The auxiliary spring 206 helps support the natural spring for reliability. The SD position has a variance to permit for lower required tolerances of other parts in the system by moving and touching the liquid sensors to the SD surface. The mounting of the liquid sensor 202 can be performed by using adjustable nuts on the surface of the sensors. This permits for adjustability of the sensors either toward or away from the SD to be detected. The mounting surface of these adjustable nuts is staggered to permit for the two liquid sensors to be as close to each other as possible. The top liquid sensor checks to see if the SD is full of liquid, while the bottom liquid sensor checks to see if there is a SD in place, full or empty, and can also detect when the SD is less than 100% full, which the processor can use for inventory tracking and reporting. The liquid sensor is also used for more accurate positioning to determine the center of the SD so the carousel can line up with the cup to pour with greater accuracy.

FIG. 9 illustrates an example side view of a liquid volume sensing component, and various liquid dispensers aligned to provide a mixed liquid to a container according to example embodiments. Referring to FIG. 9, the components from FIG. 8 are illustrated as being integrated with the base of the other liquid distribution system based on the liquid gun 140. The ring of the pusher element 170 actuates linearly to supply force to dispense from the SD reservoir 120. The servo horns 142 and motor 154 are ready to trigger gun buttons to provide additional elements of the mixed beverage. The pusher element 170 is secured by the guide rail 177 disposed in both sides of the sleeves 172. The lead screw 173 provides an actuation of the pusher element 170 to rise and press against the dispenser 121 while the correct bottle is in position with the container below.

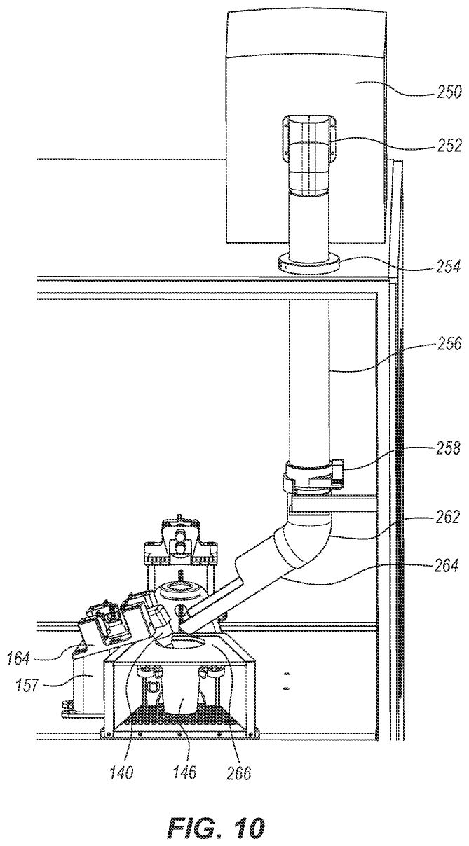

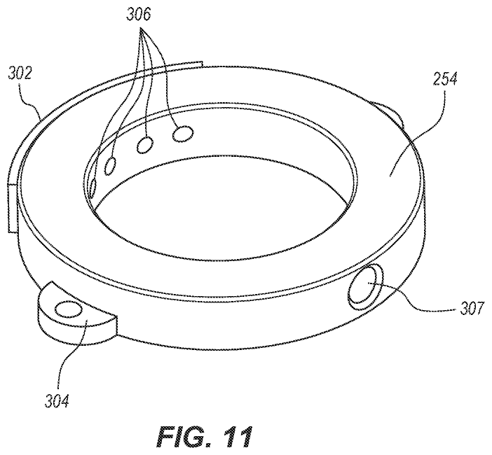

FIG. 10 illustrates an ice dispensing configuration integrated with the liquid measurement and distributing configuration according to example embodiments. Referring to FIG. 10, the ice dispenser is aligned to drop ice cubes or pellets from an ice maker 250 through a chute 252 to pass an ice sensing ring 254 (see, for example, FIG. 11) which has sensing capabilities which are part of the control function of the computer system. For example, if a user preference indicates two or three ice cubes, the ring 254 can measure and determine when the ice should be started and stopped from dispensing into the dispenser area. Tubing 256 permits the ice to flow through an elbow 262 and an angled ice luge 264 into the dispense slot 266. An ice door 258 may be a motorized door that opens and closes to permit or deny ice from entering the dispense slot 266. The gun 140 and corresponding components are also illustrated to demonstrate the various beverage populating components. In this illustration of FIG. 10, the bottle(s) and carousel were omitted for simplicity.

The icemaker 250 and dispenser are integrated so a processor communicates and send commands to the central processor on the computer and receives commands from the central processor. When the device is turned on, the ice maker 250 powers-on and is given a command to start making ice by a central processor. At the time an order is received, an auger in the ice machine turns and feeds the ice out to the pipes. The number of cubes dispensed are measured using the ice ring 254 mounted to be contiguous with the vertical ice piping. In the ice ring 254, line lasers and/or break-beam sensors (for example, transmitters and receivers) or other optical elements are used to shine or broadcast into the vertical ice pipe and when a cube falls, it will be sensed by the optical system and counted. Each time an ice pellet is dispensed, the sensor communicates with the central processor, and the count is incremented until the desired number of cubes are dispensed, at which point the processor directs the auger in the ice machine to stop turning. The cubes fall to the ice door 258 which catches the cubes and brings their velocity to zero. When the appropriate number of cubes have fallen to the ice door, the central processor directs the ice door, which is motor/sensor actuated, to open and release the ice down the angled ice luge into the cup/glass at the dispensing point. An arrangement for a direct vertical drop from the ice door into the cup/glass, without the angled ice luge, can also be implemented. To prevent ice from clumping, there are custom protocols directed by the central processor to keep the agitator moving cubes around, and custom agitator components to separate and prevent the clumping of the ice.

FIG. 11 illustrates an ice sensing ring utilizing sensors to measure ice distribution to a point of dispensing according to example embodiments. Referring to FIG. 11, the ice ring 254 has photo receptor holes 306, a cover 302, mounting flanges 304 and a laser or other broadcasting sensor mounting port 307 so a laser or other broadcasting sensor can transmit a beam across a cross-sectional area of the ring which is detected by a sensor on the other side of the ring. As the beam is interrupted a counter may identify the interruption as a single ice pellet or multiple ice pellets. The ring design can also accommodate other kinds of sensors.

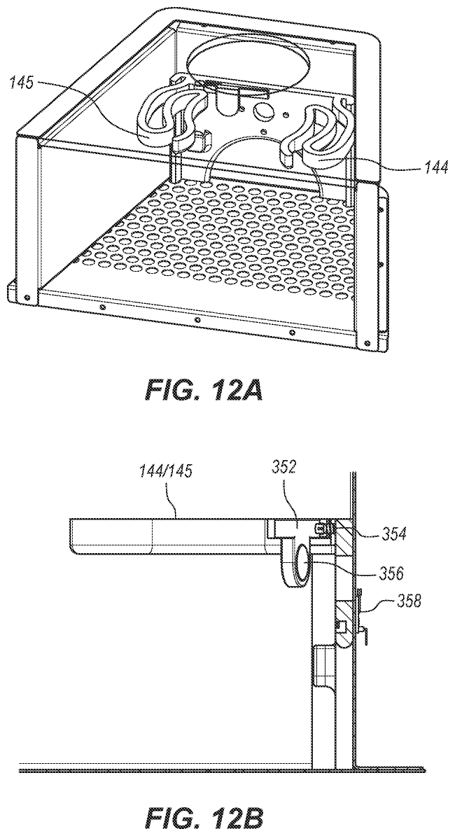

FIG. 12A illustrates a container sensing and securing configuration according to example embodiments. Referring to FIG. 12A, the beverage dispensing area has a grate to catch spilled liquid and a pair of arms 144/145 to hold the container in position and to sense whether a container is present by a spring-loaded level sensing mechanism that notifies the computer that the container is pressing against the arms.

FIG. 12B illustrates a container sensing and securing configuration according to example embodiments. Referring to FIG. 12B, the arms 144/145 are contiguous with a lever arm 352 attached to a compression spring 354 and a magnet 356. A ‘Hall Effect’ or other proximity type of sensor 358 is also mounted to the rear. The arms stabilize a cup in a stationary position while liquid and ice are dispensed and provide the framework for the magnet 356 and magnet sensing components. The lever arm 352 is responsible for housing the small magnet 356 and also acting as a mechanism to be moved by a cup, and retracting to its original position using a spring 354. The distance from the pivot point on the arms to the end of the lever compared to the distance from the same pivot point to the spring attachment provides the cup with a mechanical advantage during the actuation process and acts as a force multiplier for the cup, reducing the required force to actuate the lever arm, and move the magnet.

One example embodiment includes using magnetic fields, such as the ‘Hall Effect’ sensor 358 mounted outside of the drink box, that detect changes in magnetic fields, which are manipulated by the position of the magnet during the actuation process. Introducing a cup into the arms pushes the lever arm 352 towards the rear of the drink box, moving the magnet 356 closer to the ‘Hall Effect’ sensor 358, while simultaneously rotating the magnet 356 to be perpendicular to the sensor 358. The sensor is able to detect an increase in the magnetic field and determine the presence or absence of a cup. In the example of FIG. 12B, the lever arm 352 is in its resting position, dictated by the spring 354 pushing-off of the gripper. This position is around 30 degrees to around 45 degrees from the back of the cup gripper. At this point, the sensor will not detect the magnetic field of the magnet.

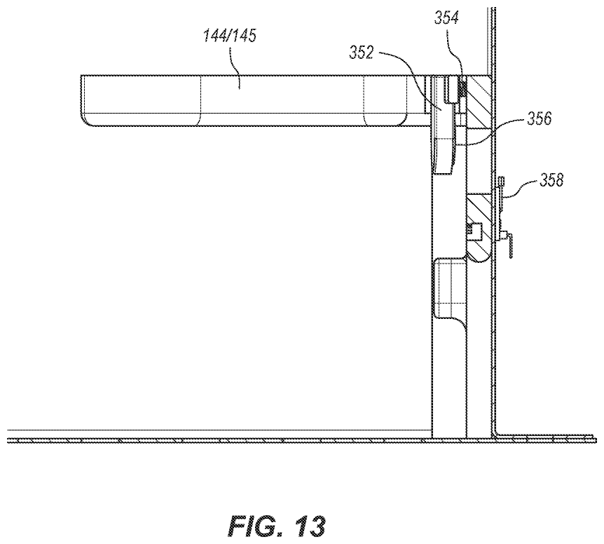

FIG. 13 illustrates a sideways view of a container sensing and securing configuration according to example embodiments. Referring to FIG. 13, the position of the lever 253 appears in an engaged position (i.e., moved back in an instance that a cup was present). The lever 253 is moved from a resting position to a near parallel position with the back of the arms 144/145, decreasing the distance between the magnet (or non-contact material to be ‘sensed’) and the sensor, and creating a near perpendicular angle between the sensor and the magnet (or non-contact material to be ‘sensed’). At this point, the sensor 358 will detect the field of the magnet 356 and a cup is identified as being present.

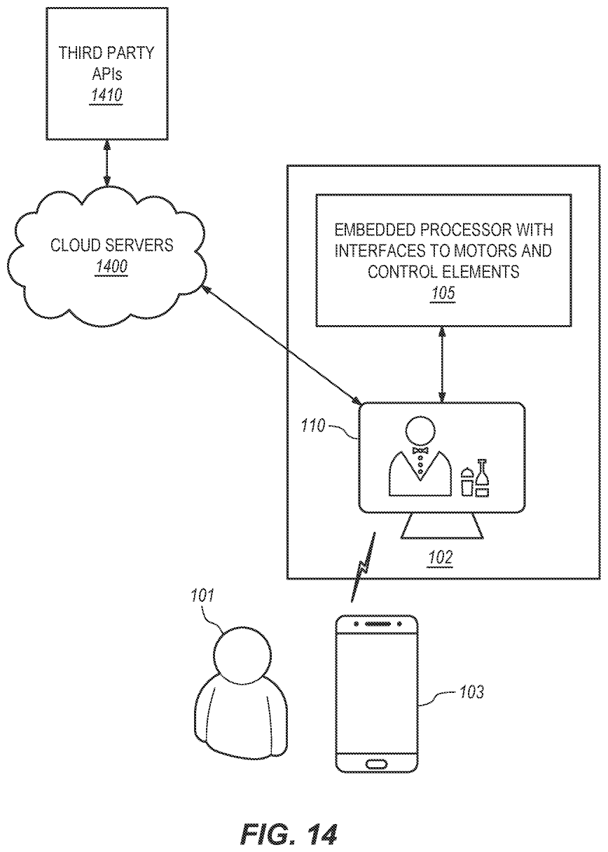

FIG. 14 illustrates a network system diagram of the devices and network elements used to control and operate the beverage dispensing device 102 according to example embodiments. Referring to FIG. 14, a user 101 uses a mobile device, smartphone or other computing device 103 to communicate with the machine 102. A computer interface 110 may provide a display that offers a drink menu or other options as described in this disclosure. The computer portion of the device 102 also has an embedded processor, instructions, memory and other computing elements necessary to receive input directly from the interface 110 or via a device 103 to compute the beverage order information and instruct the embedded processor and control elements 105 to perform various mechanical and digital operations. The communication may be via cellular, Wi-Fi or other Internet connections (TCP/IP etc.) and the data shared may include a customer profile, order, order progress, payment information, purchase history, etc. An application on the user device 103 may be integrated with a third party service, such as an ordering platform for food, beverages, and other items. There may be an identification checking process, ticketing, payment processing, reporting and analytic information, etc., via the APIs 1410 accessed via the cloud server 1400. The data from an order may be payment processing, logs from embedded devices, number of drinks ordered within a time period, notification, alerts, coupons, order confirmation, completion status, images, videos, etc. The elements 105 and 110 may provide sensor information, payment status, inventory information commands, starting and stopping commands, actuation commands, liquid dispensing commands, etc. to operate the elements of the device 102.

One example beverage creating device may include a computer configured to receive a beverage order via a wireless or touch screen interface, a carousel with a plurality of bottles configured to rotate one or more of the plurality of bottles into a dispense position and provide one or more liquids, via a dispense operation, to a container disposed in a beverage dispenser area based on one or more bottle selection commands included in the beverage order and received from the computer. The device may also include plurality of actuation elements affixed to a corresponding plurality of motors which actuate one or more release valves of a liquid dispenser nozzle linked to a plurality of different liquid sources to provide one or more additional dispense operations to the beverage dispenser based on one or more liquid source selection commands included in the beverage order.

The actuation elements include one or more of servo horns, levers, and arms. The order is received via an interface of the computer or via a wireless transmission. The one or more dispense operations and the one or more additional dispense operations are selected by the computer based on a type of beverage included in the beverage order. The device may also include an ice distributor configured to maneuver an amount of ice towards an ice chute aligned with the beverage dispenser area based on a measured amount of ice sensed by an ice sensor ring comprising one or more sensors, and the ice sensor ring is disposed contiguous with a circumference of an inside wall of the ice chute. The ice may be shifted by a rotating motor element towards a chute. The one or more dispense operations include a release valve attached to one or more bottle mouths of the one or more bottles opened to populate a reservoir with a liquid stored in a selected bottle, and a liquid measuring sensor which determines an amount of liquid in the reservoir based on the beverage order prior to releasing the liquid into the container. The liquid measuring sensor senses a light beam which has passed through a surface area of the reservoir while liquid populates the reservoir. The liquid measuring sensor is a proximity sensor that measures the reservoir as the liquid populates the reservoir. The proximity sensor may include one or more of a capacitive sensor, a resistive sensor, and an inductive sensor.

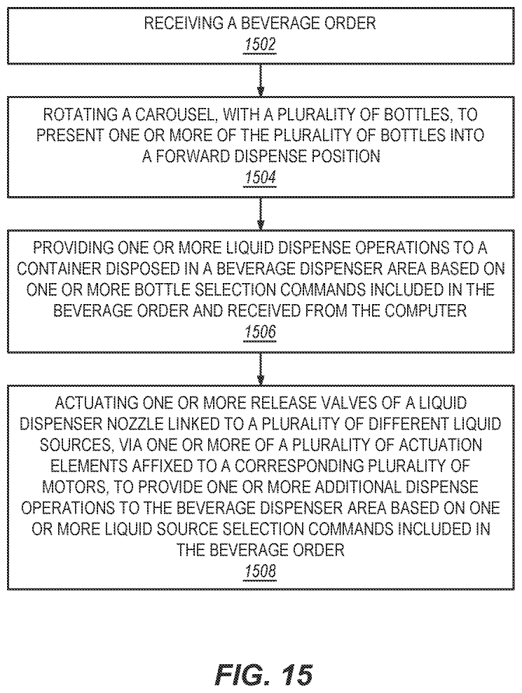

FIG. 15 illustrates a flow diagram of an example method of operation according to example embodiments. Referring to FIG. 15, the method may include one or more of: receiving a beverage order 1502, rotating a carousel, with a plurality of bottles, to present one or more of the plurality of bottles into a dispense position 1504, providing one or more liquid dispense operations to a container disposed in a beverage dispenser area based on one or more bottle selection commands included in the beverage order and received from the computer 1506 and actuating one or more release valves of a liquid dispenser nozzle linked to a plurality of different liquid sources, via one or more of a plurality of actuation elements affixed to a corresponding plurality of motors, to provide one or more additional dispense operations to the beverage dispenser area based on one or more liquid source selection commands included in the beverage order 1508.

The operations of a system, method or function described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

FIG. 16 is not intended to suggest any limitation as to the scope of use or functionality of embodiments of the application described herein. Regardless, the computing node 1600 is capable of being implemented and/or performing any of the functionality set forth hereinabove.

In computing node 1600 there is a computer system/server 1602, which is operational with numerous other general purpose or special purpose computing system environments or configurations. Examples of well-known computing systems, environments, and/or configurations that may be suitable for use with computer system/server 1602 include, but are not limited to, personal computer systems, server computer systems, thin clients, rich clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 1602 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 1602 may be practiced in distributed cloud computing environments where tasks are performed by remote processing devices that are linked through a communications network. In a distributed cloud computing environment, program modules may be located in both local and remote computer system storage media including memory storage devices.

As displayed in FIG. 16, computer system/server 1602 in cloud computing node 1600 is displayed in the form of a general-purpose computing device. The components of computer system/server 1602 may include, but are not limited to, one or more processors or processing units 1604, a system memory 1606, and a bus that couples various system components including system memory 1606 to processor 1604.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 1602 typically includes a variety of computer system readable media. Such media may be any available media that is accessible by computer system/server 1602, and it includes both volatile and non-volatile media, removable and non-removable media. System memory 1606, in one embodiment, implements the flow diagrams of the other figures. The system memory 1606 can include computer system readable media in the form of volatile memory, such as random-access memory (RAM) 1610 and/or cache memory 1612. Computer system/server 1602 may further include other removable/non-removable, volatile/non-volatile computer system storage media. By way of example only, storage system 1614 can be provided for reading from and writing to a non-removable, non-volatile magnetic media (not displayed and typically called a “hard drive”). Although not displayed, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory 1606 may include at least one program product having a set (e.g., at least one) of program modules that are configured to carry out the functions of various embodiments of the application.

Program/utility 1616, having a set (at least one) of program modules 1618, may be stored in memory 1606 by way of example, and not limitation, as well as an operating system, one or more application programs, other program modules, and program data. Each of the operating system, one or more application programs, other program modules, and program data or some combination thereof, may include an implementation of a networking environment. Program modules 1618 generally carry out the functions and/or methodologies of various embodiments of the application as described herein.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Computer system/server 1602 may also communicate with one or more external devices 1620 such as a keyboard, a pointing device, a display 1622, etc.; one or more devices that enable a user to interact with computer system/server 1602; and/or any devices (e.g., network card, modem, etc.) that enable computer system/server 1602 to communicate with one or more other computing devices. Such communication can occur via I/O interfaces 1624. Still yet, computer system/server 1602 can communicate with one or more networks such as a local area network (LAN), a general wide area network (WAN), and/or a public network (e.g., the Internet) via network adapter 1626. As depicted, network adapter 1626 communicates with the other components of computer system/server 1602 via a bus. It should be understood that although not displayed, other hardware and/or software components could be used in conjunction with computer system/server 1602. Examples include, but are not limited to: microcode, device drivers, redundant processing units, external disk drive arrays, RAID systems, tape drives, and data archival storage systems, etc.

In one embodiment, the device 102 may include a secondary slot and additional components (not shown) that communicate with the interface 110 and the computer system 1602 to place and receive edible items. These edible items can be stored in the device 102 or delivered from a different location (for example, an establishment the device 102 is located in). These edible items may be recommended based on a beverage selection that has been made. Further, the nozzle, and/or an additional port or syringe (not shown) may be used to dispense liquids such as lavender, lemon grass, mint, bitters, berries, etc. The computer 1602 can provide data regarding an amount, type and time associated with the beverages and edible items that are ordered/consumed. Offers and recommendations can be made to prospective customers based on inventory 102 and/or in the establishment the device is located in via communication that occurs between the computer 1602 and a computer (not shown) at the location. Also, bottles may be placed on the carousel 108 in a particular order to ensure certain bottles are visible through the window 106. This placement can be made prior to a selection of a beverage during the beverage making process or after the beverage making process. In other embodiments, the elements described and/or depicted herein can be configured to provide one or more of the following: selection/distribution of an amount of alcohol (example, a single, a double, a half or alcohol-free/mocktail), receiving multiple orders and making multiple drinks at or around the same time, providing an option for a user to select intolerances or allergies prior to a drink being made, ability to pre order a drink and have it be prepared at a particular time and/or location, hold a beverage and/or a glass/receptacle in a refrigerated compartment before being served, choose type of glass/receptacle, based on choice of glass specific ice is chosen, i.e., square, circular, crushed, shaved, pellets, etc. ice chosen based on user selection, drink selection, glass/receptacle selection, choose level of sweetness, tartness, smokiness, etc.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A device comprising:
a computer configured to receive a beverage order;
a carousel configured to:
hold a plurality of bottles,
rotate one or more of the plurality of bottles into a dispense position, and
provide one or more liquid dispense operations to a container disposed in a beverage dispenser area based on one or more bottle selection commands included in the beverage order;
a single degree of freedom actuation element affixed to a motor, wherein the single degree of freedom actuation element actuates a release valve of a liquid dispenser nozzle that is linked to a plurality of different liquid sources to provide one or more additional dispense operations to the beverage dispenser area based on one or more liquid source selection commands included in the beverage order, and
a smart component that controls the plurality of bottles.

2. The device of claim 1, wherein the single degree of freedom actuation element comprises:
rotatable servo horns, rotatable levers, or rotatable arms.

3. The device of claim 1, wherein the order is received via an interface of the computer or via a wireless transmission.

4. The device of claim 1, wherein the one or more dispense operations and the one or more additional dispense operations are selected by the computer based on a type of beverage included in the beverage order.

5. The device of claim 1, comprising:
an ice distributor configured to maneuver an amount of ice towards an ice chute aligned with the beverage dispenser area based on a measured amount of ice sensed by an ice sensor ring comprising one or more sensors, wherein the ice sensor ring is disposed contiguous with a circumference of an inside wall of the ice chute.

6. The device of claim 1, further comprising:
a release valve attached to one or more bottle mouths of the one or more of the plurality of bottles in the dispense position to fill a reservoir with a liquid stored in a selected bottle; and
a liquid measuring sensor that determines an amount of liquid in the reservoir based on the beverage order before releasing the liquid into the container, wherein the liquid measuring sensor is separate from the release valve and the reservoir, and the liquid measuring sensor confirms or denies that the required volume of liquid is present to complete the order to prevent pouring out a partial volume of liquid.

7. The device of claim 6, wherein the liquid measuring sensor is an optical sensor that senses a light beam passing the reservoir.

8. The device of claim 6, wherein the liquid measuring sensor is a proximity sensor that measures the reservoir as the liquid fills the reservoir.

9. The device of claim 5, further comprising:
an ice door disposed in the ice chute, wherein the ice door is maintained in a closed position until the ice door opens based on a signal from the ice ring sensor indicating that a certain amount of ice is present in the ice chute.

10. A method comprising:
receiving a beverage order from a computer;
in response to the beverage order, rotating a carousel comprising a plurality of bottle holders, configured to hold bottles, to position one or more of the bottles into a dispense position;
verifying that the carousel is rotated to the dispense position based on an output of a sensor;
verifying a presence of a container to receive liquid in a beverage dispense area based on an output of a sensor;
providing one or more liquid dispense operations to the container disposed in the beverage dispenser area based on one or more bottle selection commands included in the beverage order; and
actuating a release valve of a liquid dispenser nozzle linked to a plurality of different liquid sources via a single degree of freedom actuation element affixed to a motor to provide one or more additional dispense operations to the beverage dispenser area based on one or more liquid source selection commands included in the beverage order; and
verifying that the container has been removed from the beverage dispense area based on an output of a sensor.

11. The method of claim 10, wherein the single degree of freedom actuation element comprises elements comprise one or more of:
rotatable servo horns, rotatable levers, or rotatable arms.

12. The method of claim 10, wherein the order is received via an interface of the computer or via a wireless transmission.

13. The method of claim 10, wherein the one or more dispense operations and the one or more additional dispense operations are selected by the computer based on a type of beverage included in the beverage order.

14. The method of claim 10, comprising:
maneuvering, via an ice distributor, an amount of ice towards an ice chute aligned with the beverage dispenser area based on a measured amount of ice sensed by an ice sensor ring comprising one or more sensors, wherein the ice sensor ring is disposed contiguous with a circumference of an inside wall of the ice chute.

15. The method of claim 10, further comprising:
filling a reservoir with a liquid stored in a selected bottle via a release valve attached to one or more bottle mouths of the one or more of the plurality of bottles in the dispense position; and
determining an amount of liquid in the reservoir based on the beverage order before releasing the liquid into the container via a liquid measuring sensor.

16. The method of claim 15, wherein the liquid measuring sensor is an optical sensor that senses a light beam passing through the reservoir.

17. The method of claim 15, wherein the liquid measuring sensor is a proximity sensor that measures the reservoir as the liquid fills the reservoir.

18. The method of claim 14, further comprising:
maintaining an ice door disposed in the ice chute in a closed position;
detecting that a certain amount of ice is present in the ice chute by the ice ring sensor; and
opening the ice door in response to a signal from the ice ring sensor indicating that the certain amount of ice is present.

19. A non-transitory computer-readable storage medium configured to store instructions that, when executed by a processor, cause the processor to perform:
receiving a beverage order from a computer;
in response to the beverage order, rotating a carousel comprising a plurality of bottle holders, configured to hold bottles, to position one or more of the bottles into a dispense position;
providing one or more liquid dispense operations to a container disposed in a beverage dispenser area based on one or more bottle selection commands included in the beverage order; and
actuating a release valve of a liquid dispenser nozzle linked to a plurality of different liquid sources via a single degree of freedom actuation element affixed to a corresponding motor to provide one or more additional dispense operations to the beverage dispenser area based on one or more liquid source selection commands included in the beverage order.

20. The non-transitory computer-readable storage medium of claim 19, wherein the instructions further cause the processor to perform:
maneuvering, via an ice distributor, an amount of ice towards an ice chute aligned with the beverage dispenser area;
opening an ice door disposed between an ice maker and the ice chute to allow the amount of ice to enter the ice chute based on a measured amount of ice sensed by an ice sensor ring comprising one or more sensors, and wherein the ice sensor ring is disposed contiguous with a circumference of an inside wall of the ice chute.
